(19) United States
(12) Patent Application Publication
(10) Pub. No.: US 2015/0209802 A1
(43) Pub. Date: Jul. 30, 2015

(54) Combined Decanter Centrifuge and Dryer

(71) Applicant: HiFlo, LLC, Conroe, TX (US)

(72) Inventors: Clifford L. Hilpert, Conroe, TX (US); Jeffrey L. Hilpert, Conroe, TX (US)

(73) Assignee: HiFlo, LLC, Conroe, TX (US)

(21) Appl. No.: 14/162,980

(22) Filed: Jan. 24, 2014

(51) Int. Cl. B04B 1/20

(52) U.S. Cl. CPC B04B 1/20

(57) ABSTRACT

An apparatus for treating a suspension that includes liquid and solid particles of varying sizes has a first decanter type centrifuge that discharges the solids onto a dryer/filter element that further separates the liquid from the solids in the suspension.

### BACKGROUND OF INVENTION

1. Field of the Invention

The invention disclosed and claimed in this application relates to a decanter centrifuge which is typically utilized in a variety of industrial processes where it is necessary to separate out solids that are suspended in a liquid medium. As an example, decanter centrifuges are used in oil and gas well drilling to separate out solid particles that are recirculated back to the surface as a result of drilling through the formation. Such drilling fluids are commonly referred to as mud. Other well treating processes also may result in fluids being returned to the surface. These fluids may also be treated using decanter centrifuges.

2. Description of Related Art

U.S. Pat. No. 4,731,182 is an example of typical decanter centrifuge. It consists of an outer bowl 33 within a casing 34. Positioned within the bowl is a screw conveyor having a core 15 and helical vanes 15a and 15b. Sludge or drilling mud is directed into the interior of core 15 and exits through ports 35 into bowl 33. Bowl 33 and the screw conveyor are driven at different speeds. The heavier phase accumulates at the inner surface of bowl 33 by centrifugal force and is moved by vanes 15b to outlet 39 while the lighter phase is discharged through outlets 36.

U.S. Pat. No. 6,823,605 discloses an apparatus that includes a baffle cone 14 that intercepts the larger particles from outlet 11 and directs them into a hot gas stream for drying the particles.

### BRIEF SUMMARY OF THE INVENTION

The present invention enhances the performance of typical decanter centrifuges by adding a dryer mechanism at the output area for the heavier particles. The dryer is designed to remove liquid and some smaller particles as the larger solids pass over the dryer filter.

This arrangement eliminates the need for separate centrifugal dryers that are typically used to treat the heavier particles separated out by the decanter centrifuge, thus saving money and the extra space needed for the dryers at the well site.

### BRIEF DESCRIPTION OF THE SEVERAL VIEWS OF THE DRAWING(S)

FIG. 1 is a cross sectional view of a combined decanter centrifuge and dryer according to an embodiment of the invention.

### DETAILED DESCRIPTION OF THE INVENTION

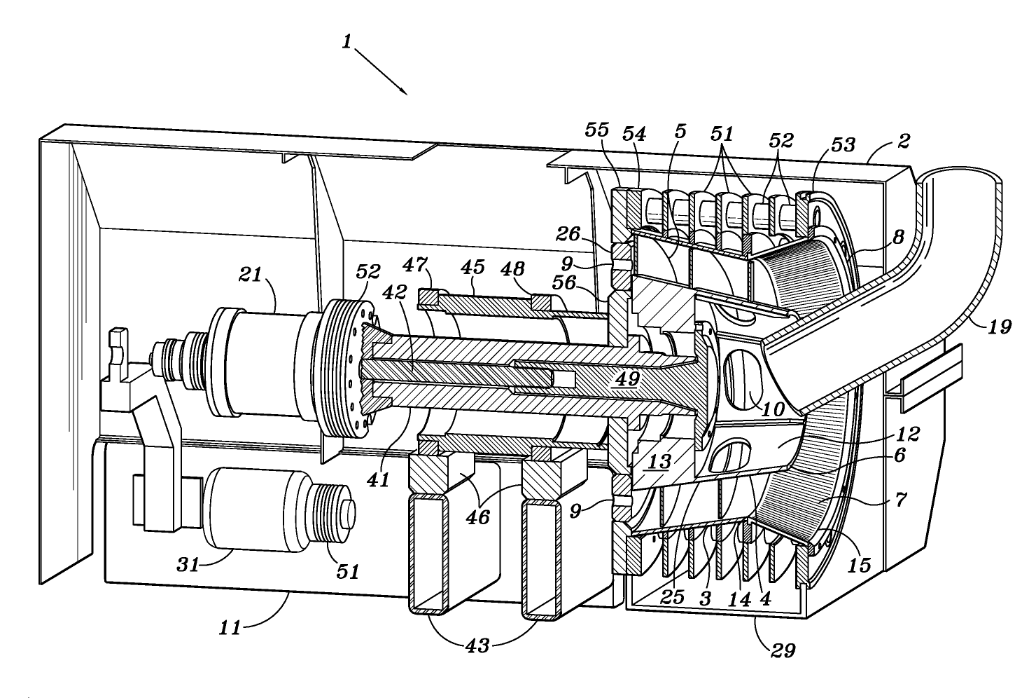

Referring to FIG. 1, an embodiment of the invention includes a decanter centrifuge 1 including a support housing 11 and a cover 2 pivotably mounted on the housing. A transmission mechanism 21 is provided to rotate inner cone shaped screw conveyor 4 and outer bowl 3 at different rotational speeds as is known in the art. A suitable drive mechanism including motor 31 and pulley 51 is connected to transmission mechanism 21. Screw conveyor 4 includes a hollow frustoconical end portion 12 and a solid portion 13. Helical vanes 5 are located on the outer surface of the screw conveyor 4. The liquid/solid mixture to be processed is directed into the interior portion 12 of the screw conveyor by inlet tube 19. Interior portion 12 of screw conveyor 4 is provided with a plurality of outlets 10 which allow for the liquid/solid mixture to be flung outwardly against the inner surface of bowl 3. As explained above, due to centrifugal force the heavier particles in the mixture will congregate at the inner surface of bowl 3 and be directed towards outlet area 14 by vanes 15. Liquid with some fine solid particles will congregate at the outer surface 25 of the screw conveyor 4, and will exit through outlet openings 9 in annular member 26.

Screw conveyor 4 is driven by shafts 42 and 49 which are secured to solid portion 13. Outer bowl 3 and dryer 7 are driven by shaft 41 through annular members 56, 26, and 55 which are secured to each other and shaft 41. Bowl 3 includes a plurality of discs 51 and spacers 52 and a terminal ring member 53 which are held together in a suitable manner. Dryer 7 is held in place by a flange 8 extending from ring 53 and a groove provided in one of the discs 51 positioned at the outlet of bowl 3. Housing 11 includes supports 43 which support annular members 47, 48, which in turn support cylindrical member 45. Member 45 is the support housing for the main bearings (not shown) that support shaft 41.

Attached to the discharge outlet portion 14 of bowl 3 is a dryer filter 7 in the form of an outwardly expanding conical ring. As the heavier particles are discharged over end portion 14 of bowl 3, they are directed over filter medium 7. Liquid and some remaining fine particles smaller than a pre-selected size, for example less than 200 microns, pass through the filter medium 7 and are collected in a suitable reservoir 29. Larger solid particles pass over the filter medium 7 and are discharged over the outer portion of the dryer filter and are collected in a suitable manner.

Thus it can be seen that the invention includes treating the slurry or mud in two distinct ways in one apparatus. Liquid with fine particles is first separated from a suspension of heavier particles. The remaining mixture of heavier particles and liquid is then passed over a rotating dryer filter where the heavier particles are further separated from any remaining liquid and smaller particles. The liquid recovered from the first and second stage may then be recycled for use in the process such as a drilling process.

Although the present invention has been described with respect to specific details, it is not intended that such details should be regarded as limitations on the scope of the invention, except to the extent that they are included in the accompanying claims.

I claim:

1. Apparatus for separating and drying solid particles from liquid in a suspension comprising:
a support housing;
an outer bowl rotatably supported by the support housing;
a rotatable screw conveyor supported within the bowl;
an inlet for directing the suspension to the screw conveyor;
a spiral vane on the outside of the screw conveyor;
a first outlet for liquid located near an outer surface of the screw conveyor;
a second outlet for the particles of the suspension; and
a dryer element located at the second outlet for further separating the solid particles from the liquid in the suspension.

2. The apparatus of claim 1 further including drive means for rotating the outer bowl and screw conveyor.

3. The apparatus of claim 1 wherein the dryer comprises an outwardly expanding frustoconical filter element.

4. The apparatus of claim 1 further including a hood pivotably connected to the support housing.

5. The apparatus of claim 2 wherein the screw conveyor and bowl are rotated at different speeds.

6. The apparatus of claim 1 wherein the dryer element is attached to the outer bowl.

7. The apparatus of claim 1 wherein the second outlet is located at the downstream end of the outer bowl.

8. The apparatus of claim 1 wherein the screw conveyor has a hollow portion and the inlet directs fluid into the hollow portion.
